(19) United States
(12) Patent Application Publication
(10) Pub. No.: US 2004/0166975 A1
(43) Pub. Date: Aug. 26, 2004

(54) Timing belt autotensioner with an anti-tooth skip mechanism

(76) Inventor: Fabian W. Gibson, Stockholm (SE)

Correspondence Address: James M. Deimen, Suite 300, 320 N. Main Street, Ann Arbor, MI, 48104-1192, US

(21) Appl. No.: 10/628,313

(22) Filed: Jul. 28, 2003

Related U.S. Application Data
(63) Continuation-in-part of application No. 10/296,763, filed on Jun. 24, 2003.
Application No. 10/296,763 is a 371 of international application No. PCT/IB01/01268, filed on Jun. 15, 2001.
(60) Provisional application No. 60/213,802, filed on Jun. 16, 2000.

(51) Int. Cl. F16H 7/12

(52) U.S. Cl. 474/112

(57) ABSTRACT

A timing belt autotensioner includes a mechanism actuated by the reversal of timing belt movement direction. In automotive applications reversal of timing belt direction occurs only rarely under inadvertent or accidental circumstances. Such reversals can cause belt slackening sufficient for a toothed belt to jump gear teeth thereby changing engine cam shaft timing. Four related mechanisms are disclosed, each of which will, upon actuation by belt reversal cause the autotensioner pulley axis of rotation to move in a direction that tightens the belt during reverse movement of the belt. Thus, the belt remains tight to the toothed pulleys preventing jump or skip of the belt until the belt returns to proper forward belt movement. A torque limiter incorporated in the mechanism limits to a predetermined amount the torque generated in the mechanism by the reverse movement of the belt.

### BACKGROUND OF THE INVENTION

This application is a continuation-in-part of national U.S. application Ser. No. 10/296,763, filed Dec. 13, 2002, and claims the benefit of international application No. PCT/IB01/01268, filed Jun. 15, 2001, and U.S. provisional patent application No. 60/213,802, filed Jun. 16, 2000.

This invention relates to the field of belt tensioners and belt tensioner systems. More particularly, the present invention relates to improvements in both mechanical type and hydraulic type belt tensioners for use with a camshaft belt drive system in automotive engine applications and the like.

A timing belt trained about two cooperating pulleys is well-known in the art of tension transmitting assemblies. There are economical advantages to the aforementioned when compared with other types of assemblies, specifically meshing gear assemblies. It is known to use an automatic tensioner in conjunction with a synchronous or timing belt drive system in order to compensate for tension variations in the belt. These variations are commonly attributable to dynamic effects such as cyclic torque variations and thermal effects that introduce changes in the length of a timing belt drive.

A tensioner is located on the normally slack side of the belt span in a belt drive system. Tensioner design is typically divided into two groups: mechanical tensioners, relying on coulomb friction as means to generate damping; and second, hydraulic tensioners, generally having a piston arrangement with a known leak-through and a one-way valve to create an asymmetrical damping which is proportional to speed. While these types of tensioners are designed to accommodate cyclic torque variations and thermal effects in a belt drive system by controlling belt tension at the slack side of the belt span, such tensioners are not designed to accommodate extreme torque reversal situations (kickback), such as engine backfiring or engine rotation in reverse (e.g., an automobile going backward while in forward gear with the clutch engaged).

In such extreme torque reversal situations, the slack side of the belt drive system becomes the tight side. The tight belt tension, on the normally slack side, causes the tensioner device to respond to the kickback and rapidly decrease belt tension by moving the pulley and its related pivot-arm away from the belt to slacken the tight side of the belt span. If the pulley movement is extreme, it can over-slacken the belt and result in tooth jump or ratcheting as the slackened belt enters the crank pulley or cam shaft pulleys. Tooth jump or ratcheting is deleterious to the operation of an engine as synchronization of the pulleys is lost.

Some tensioners have a ratchet and pawl mechanism attached to the tensioner's pivot arm to eliminate tensioner kickback and avoid tooth jump or ratcheting. U.S. Pat. No. 4,299,584 discloses a ratchet operative with a leaf-spring pawl that allows some compliance at kickback by permitting the leaf-spring to deflect slightly. U.S. Pat. No. 4,634,407 also teaches a ratchet and pawl mechanism where the ratchet operates as a one-way clutch that fixes the position of a pivot-arm such that the tensioner cannot operate to slacken the belt.

However, a common problem of ratchet/pawl devices is that the tensioner must operate primarily as a fixed idler in one direction as the ratchet mechanism limits the motion of the tensioner pivot-arm. In other words, the tensioner pivot-arm is unable to function in a direction that would allow the belt to be slackened. Under this condition, belt tooth failure and noise is reintroduced into the belt drive system when the belt cannot be at least partially slackened.

U.S. Pat. No. 5,591,094 teaches an adjustable stop spaced at a distance from the pivot-arm when the pulley is biased in a pressing engagement against a static belt. The spacing is pre-determined to allow pivot-arm movement in a direction to slacken the belt while also preventing belt teeth from becoming disengaged from a toothed pulley (i.e., tooth jump) in an extreme torque reversal situation. The problem with an adjustable stop of this nature is that its distance from the pivot-arm is determined by compensation for the thermal effects of a hot engine. Each component of the belt drive system, however, leaves space for simultaneous tensioner arm vibration. In practice, this distance is large enough to allow tooth jump, especially under conditions such as low temperature and when at least one of the belt and pulleys is covered with a coating of ice.

### SUMMARY OF THE INVENTION

The new autotensioners comprise mechanisms actuated by the reversal of movement direction of the timing belts. Such a reversal of belt movement direction, normally a very rare occurrence, usually occurs during a short period of time, after which the belt returns to its normal forward or preferred movement. Each of the four mechanisms disclosed below, upon actuation by reverse belt movement, causes the autotensioner pulley axis of rotation to move in a direction that tightens the belt during reverse movement of the belt. Mechanisms are disclosed below that apply to autotensioners which have a trailing or leading geometry relative to the belt. Applied to autotensioners engaging the slack span of the belt, the mechanisms almost instantly tighten the belt in response to the reversal of belt direction. While disclosed for an automotive application, the invention is useful for any toothed belt applications where skipping or jumping of the belts over toothed gears would be deleterious to the operation of the machines.

Although the anti-tooth skip mechanism is inherently torque limited by the maximum frictional forces that can be generated between the pulley and the belt, these maximum frictional forces will change over time with polishing and glazing of the engaging pulley and belt surfaces. Therefore, torque limiters with predictable characteristics have been developed, as disclosed below, to accurately limit the torque maximum in opposition to the abnormal belt force caused by the reversal of belt direction.

The predetermined torque is the maximum allowable for a specific timing belt system. This torque is limited by means of design geometry in or adjacent to the one-way clutch in each embodiment and can be calibrated to any desired design limit. When the torque limit is reached, the one-way clutch slips or ratchets, thus limiting the torque to the design limit.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a side elevational view of a timing belt drive system;

FIG. 2 is a side elevational view of a first embodiment of the tensioning device of the present invention;

FIG. 2a illustrates torque limitation by pawl and ratchet geometry;

FIG. 3 is a side elevational view of a second embodiment of the tensioning device of the present invention;

FIG. 4 is a side elevational view of a third embodiment of the tensioning device of the present invention;

FIG. 5 is a side elevation of a fourth embodiment of the tensioning device of the present invention;

FIG. 6 is a cross-section of an alternative form of the tensioning device including a torque limiter;

FIG. 6a is a side view of an expandable spring clip in the tensioning device of FIG. 6; and

FIG. 7 is a cross-section of the tensioning device and torque limiter of FIG. 6 fitted within bearing raceways.

### DETAILED DESCRIPTION OF THE PREFERRED EMBODIMENTS

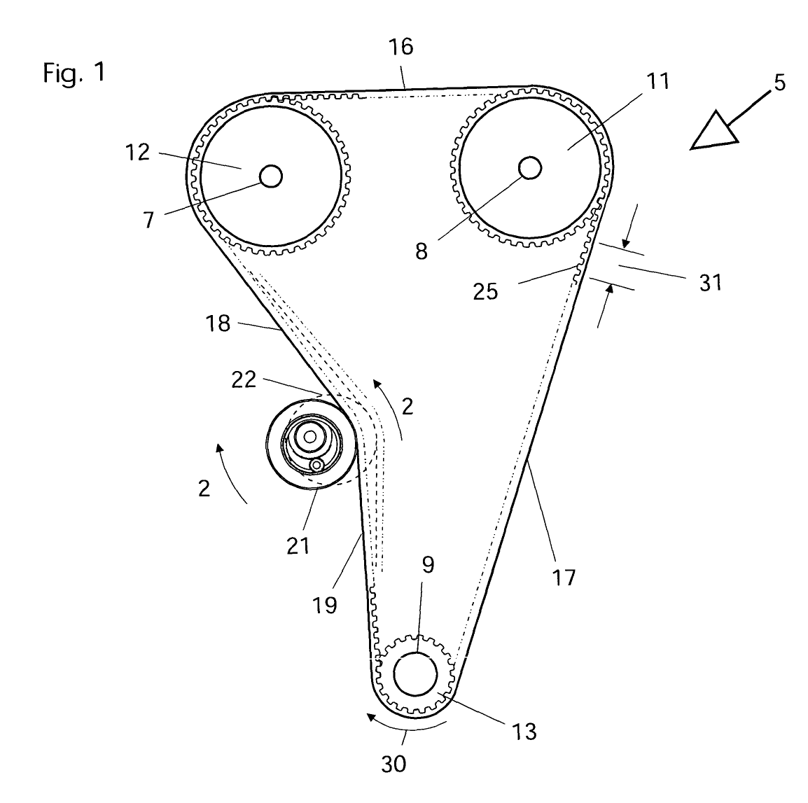

Reference will now be made to FIGS. 1 through 5.

FIG. 1 is a side elevational view of a synchronous timing belt drive 5 shown with a toothed belt comprising spans 16, 17, 18 and 19 and moving in the arrow direction 30. Teeth 25, located on the interior periphery of the belt, are spaced at multiple pitch 31. The belt is entrained and tensioned around toothed pulleys 11, 12 and 13. The pulleys are illustrated as a camshaft drive of an automotive engine design that includes two exterior toothed cam pulleys 11 and 12 on camshafts 8 and 7, and an exterior toothed crankshaft pulley 13 on crankshaft 9. A belt-tensioning device 21 is mounted in connection with these pulleys such that it is operative in conjunction with the timing belt drive 5. As the engine operates over a range of RPM's, the drive camshaft pulleys 11, 12 introduce cyclic torque variations, which cause dynamic belt tension variations in belt spans 16 through 19. The tensioning device 21 is intended to compensate as shown at 22 for torque variations, thermal growth when the engine is running, and stretch and wear of the belt which occurs during the life span of the drive 5. The arrows 2 indicate that the belt-tensioning device 21 can rotate in either direction, however, reverse belt movement can be deleterious as explained below.

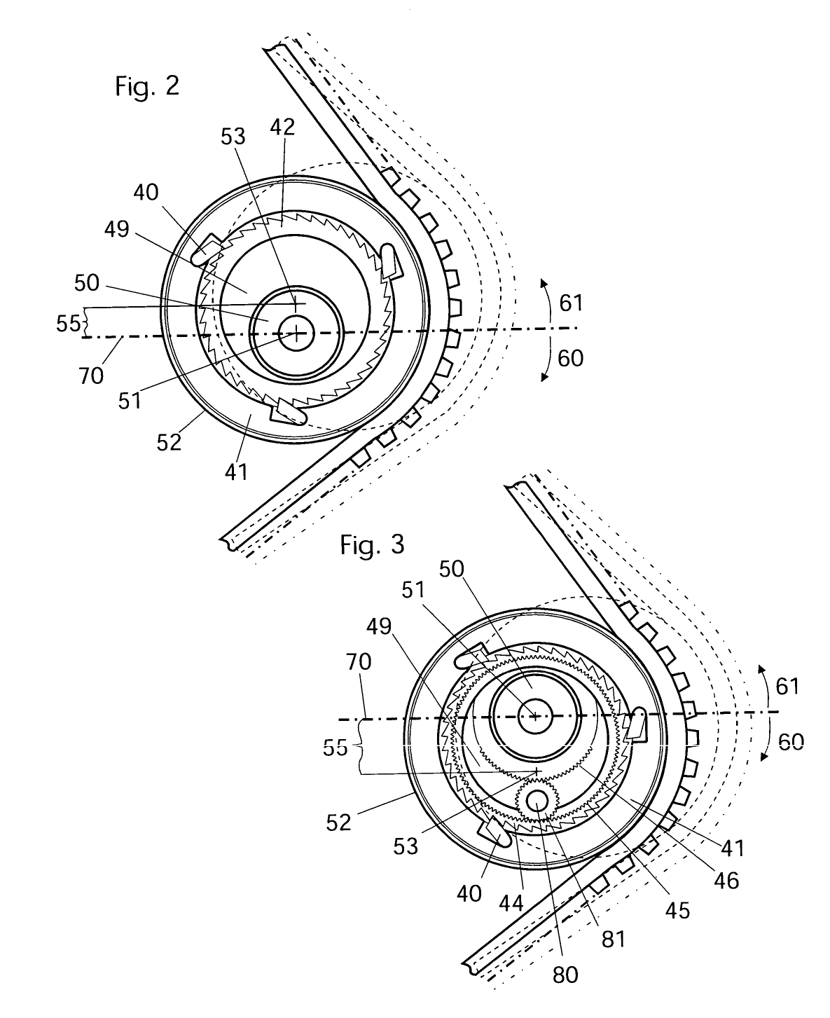

FIG. 2 illustrates a first embodiment of the present invention. The belt tensioner 21 is mounted on the engine via a pivot shaft 50 having a pivotal eccentric arm 49 to which a predetermined torque is applied, usually via a spring arrangement (not shown here). This torque generates a predetermined belt force which is transmitted to the belt via a pulley 52 attached to eccentric arm 49 by any means as is apparent to one skilled in the art, and generally through a bearing (not shown).

The tensioning device as shown in FIG. 2 is a trailing type configuration. The center 53 of arm structure 49 is located above line 70 throughout its operational range. Line 70 represents the over-center position of pulley 52 with respect to the pivot shaft 50. A ratchet wheel 42 is attached to arm structure 49. A plurality of pawls 40, located in pockets within the housing structure 41, and attached to pulley 52, bias the ratchet wheel 42 to form a one-way clutch and permit the unrestricted rotation of pulley 52 in the counterclockwise rotational direction of the drive 5 at the belt tensioner 21 as depicted by arrow 61. In the event of a clockwise rotational direction, depicted by arrow 60 and which generally occurs under kickback and rollback conditions, the pawls 40 engage ratchet wheel 42 locking the pulley 52 and eccentric arm structure 49 together. This generates frictional torque between the belt 18 and pulley 52 in the direction of arrow 60. The torque upsets the abnormal belt force caused by the belt reversal. Using an existing tensioner device typical of the prior art, pulley 52 is normally pushed in an outward belt direction as the belt force, in conjunction with the arm length 55, generates an opposing torque which overcomes the spring torque applied to the eccentric arm 49, slackening the belt, and, in turn, potentially creating tooth jump. When using the tensioning device of the present invention, the belt 18 causes engagement of the ratchet 40, 41, 42 generating torque and moving the pulley 52 toward the belt, thus increasing the belt tension temporarily on the slack side and preventing tooth jump.

Rather than rely upon the frictional forces generated between the belt and pulley 52 to limit the torque applied to the anti-tooth skip mechanism when the belt reverses into direction 60, FIG. 2a illustrates modifying the pawl 40 engagement with the teeth of the ratchet wheel 42. The geometric angle 130 between the tip 132 of the pawl 40 and the tooth surface 134 and the compliance of the housing structure 41 permits the limiting torque to be determined when the pawl 40 is forced to slip from any tooth surface 134. The engaging surfaces (tip 132 and tooth 134), as with most similar devices, are hardened for wear resistance and therefore can be expected to retain their frictional and slippage characteristics over long periods of use.

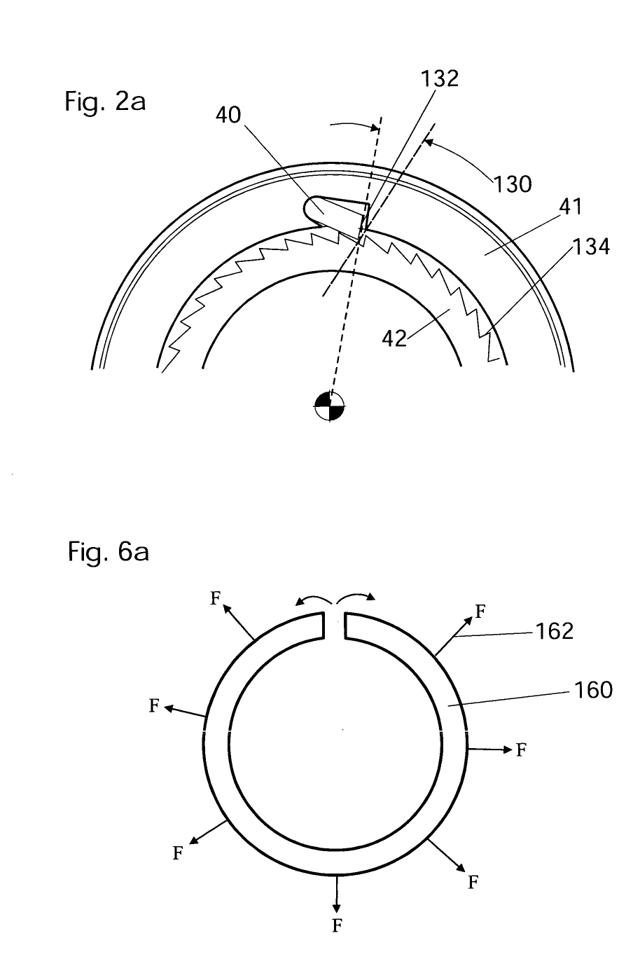

FIG. 3 is an enlarged view of the tensioning device of FIG. 1 and illustrates a second embodiment of the present invention. The tensioner 21 functions in the same manner as explained above. The tensioner as shown in FIG. 3 is a leading type configuration. The center 53 of arm structure 49 is located below the line 70 throughout its operational range. A ratchet wheel 44 is pivotally mounted on the cylindrical surface of the eccentric arm 49. A plurality of pawls 40, located in pockets within housing structure 41, attached to pulley 52 bias the ratchet wheel 44 and permit the unrestricted rotation of pulley 52 in the counterclockwise rotational direction, depicted by arrow 61 of drive 5. In the event of a clockwise rotational direction, depicted by arrow 60 and which generally occurs during kickback and rollback conditions, the pawls 40 engage ratchet wheel 44 enabling rotation of ratchet wheel 44 together with the pulley 52. The ratchet wheel 44 is meshed with gear 81 through teeth 45 on the inside of the volute. Gear 81 is pivotally mounted on a support structure 80, and is attached to the pivot structure 50 via a member not shown here for clarity. Thus, pivot structure 80 is fixed. Gear 81 is meshed with teeth 46 which are part of the eccentric arm 49. This gear train results in the eccentric arm 49 rotating toward the belt and generating an opposing torque. This opposing torque overcomes the belt force generated torque resulting from the clockwise rotational direction of the drive 5 (depicted by arrow 60), and increases the belt tension which, in turn, prevents tooth jump.

The embodiment of FIG. 3 utilizes a pawl 40 and ratchet wheel 44 in the anti-tooth skip mechanism, as in FIG. 2, therefore, the torque limiter modification shown in FIG. 2a is applicable to the mechanism of FIG. 3.

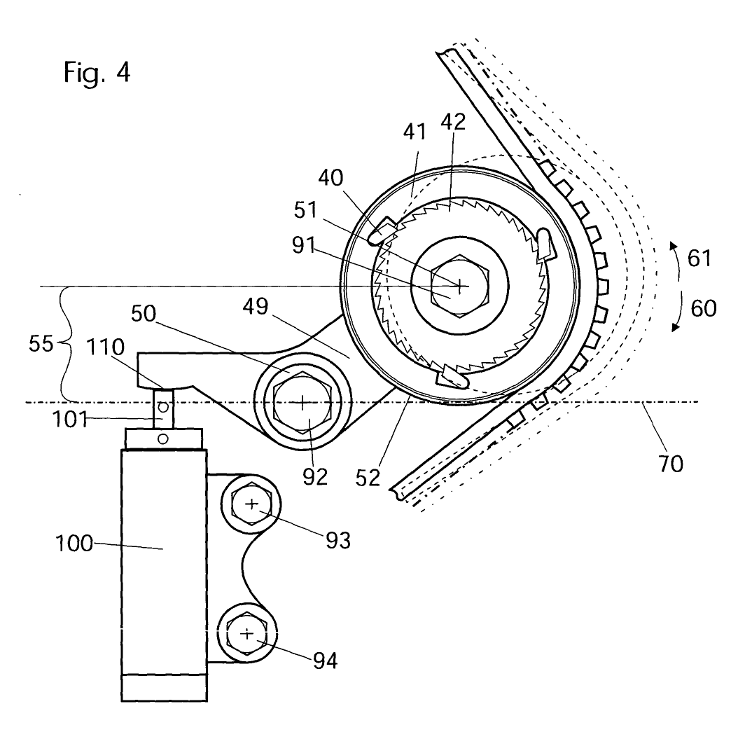

FIG. 4 illustrates a third embodiment of the present invention. The belt tensioner comprises a pulley 52, an eccentric arm structure 49, and a hydraulic actuator unit 100, mounted on an engine via a pivot shaft 50 and bolts 92, 93 and 94. Pulley 52 is attached to the eccentric arm structure 49 through a bearing fixed to the arm structure 49 via bolt 91. The arm structure 49, pivotally trained about pivot shaft 50, allows the pulley 52 to rotate eccentrically around the center of pivot shaft 50. Hydraulic actuator 100 exerts a known force through piston pin 101 at point 110 generating a predetermined torque that is transferred to arm structure 49 in conjunction with arm length 55. This generates a predetermined belt force that is transmitted to the belt via pulley 52.

The tensioner shown in FIG. 4 is a trailing type configuration. The center 51 of pulley 52 is located above line 70 throughout its operational range. Line 70 represents the over center position of the pulley 52 with respect to the pivot shaft 50. A ratchet wheel 42 is attached to the arm structure 49. A plurality of pawls 40, located in pockets within housing structure 41, attached to pulley 52 bias the ratchet wheel 42 and permit the unrestricted rotation of pulley 52 in the counterclockwise rotational direction of the drive 5 depicted by arrow 61. In the event of clockwise rotational direction, depicted by arrow 60 and which occurs during kickback and rollback conditions, the pawls 40 engage ratchet wheel 42 locking the pulley 52 and eccentric arm structure 49 together. This generates a frictional torque between the belt 18 and pulley 52 in the direction of arrow 60. The torque upsets the abnormal belt force caused by the belt reversal, moves the pulley 52 toward the belt increasing the belt tension temporarily, and, in turn, prevents tooth jump.

The embodiment of FIG. 4 utilizes a pawl 40 and ratchet wheel 42 in the anti-tooth skip mechanism, as in FIG. 2, therefore, the torque limiter modification shown in FIG. 2a is applicable to the mechanism of FIG. 4.

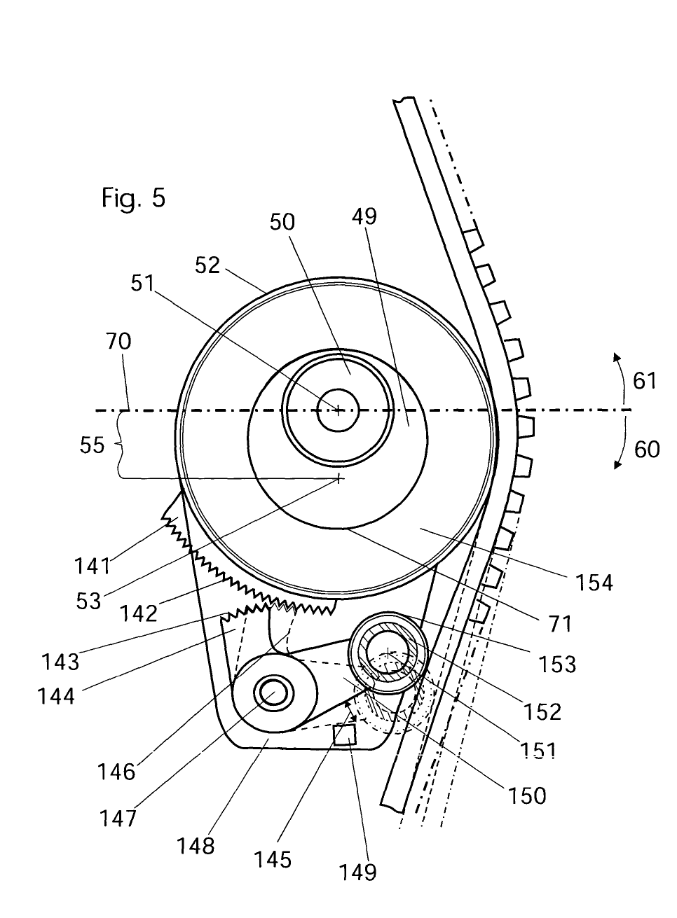

In FIG. 5, a belt tensioner 21 is mounted on the engine via a pivot shaft center 51 and has a pivotal eccentric arm structure 49 to which a predetermined torque is applied usually via a spring arrangement (not shown here). This generates a predetermined belt force which is transmitted into the belt via a pulley 52 on housing 154 attached to eccentric arm structure 49 through a bearing at 71 usually of the type known as ball or roller (not shown here). The tensioner configuration shown is of the leading type, wherein the center 53 of arm structure 49 is below the line 70 throughout its operational range as above. A second pivotal structure is mounted to the base plate 148 of the tensioner and comprises a second eccentric arm structure 150 rotatable about a pivot 147 to the dotted line position 146 and a second pulley 153 mounted by a pivot 151 to the second eccentric arm structure 150. Attached to the arm structure 150 is pawl 144 which at its tip has a gear mesh 143. Within pulley 153 is a one-way clutch 152 biasing the arm structure to permit free rotation of the pulley 153 when the belt moves normally in direction 61. When the engine kicks back or roll back occurs, the belt changes direction to 60.

The one-way clutch 152 senses this change of direction and locks pulley 153 and arm structure 150 firmly together. This causes the arm structure 150 to rotate in the direction shown by arrow 145. Pawl 144 rotates with the arm 150 resulting in the gear mesh 143 engaging mesh 142 on arm 141 which is attached to the first pivotally mounted eccentric arm structure 49. This gearing results in the eccentric arm structure 49 rotating toward the belt and generating an opposing torque that overcomes the belt force generated torque due to the abnormal direction of the drive 5 depicted by arrow 60, thus increasing the belt tension and preventing tooth jump. A stop 149 prevents over centering of the second arm structure 150.

In FIG. 5, the anti-tooth skip mechanism relies upon the second belt engaging pulley 153 and one-way clutch 152 to latch upon belt movement in the direction 60. To provide for torque limitation, the modified pawl 40 and ratchet wheel 42 of FIG. 2a may be employed on a smaller scale for one-way clutch 152.

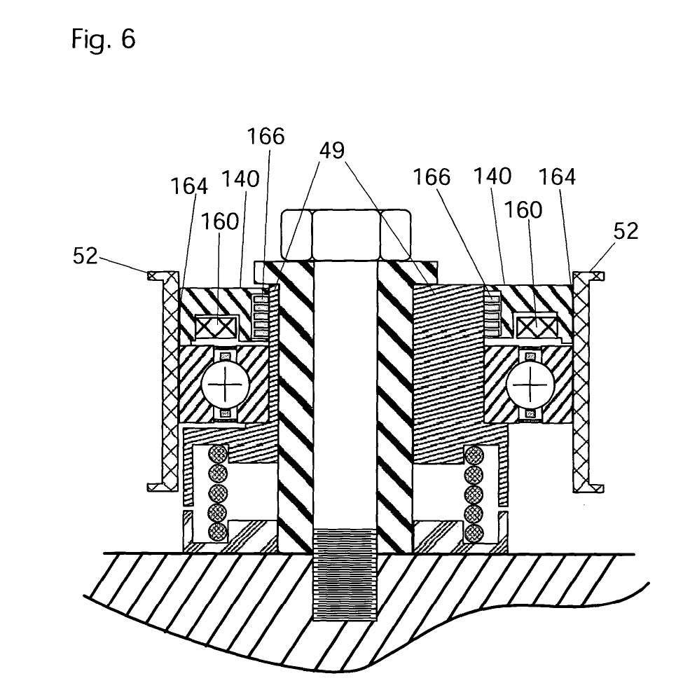

The torque limiters for the anti-tooth skip mechanisms of FIGS. 2-5 disclosed above are applied to the pawl and ratchet wheel mechanisms. Other mechanisms for accomplishing the torque limiting function are possible. FIG. 6 illustrates another form of the present invention with emphasis on the integrated construction of the one-way clutch and torque limiter features. Housing structure 140 comprises an expandable ring mounted in the pulley 52. A clip 160, also shown in FIG. 6a, is seated in housing structure 140 to provide a known expansion force. This controlled expansion force 162, in conjunction with known friction properties of the contact area 164 of the housing structure 140, will slip at a designed torque level, thus providing the torque limiter. A clutch structure 166 comprised of plural volutes is attached to, and located by, housing structure 140. This clutch 166 is trained on arm structure 49 with a known diametral engagement.

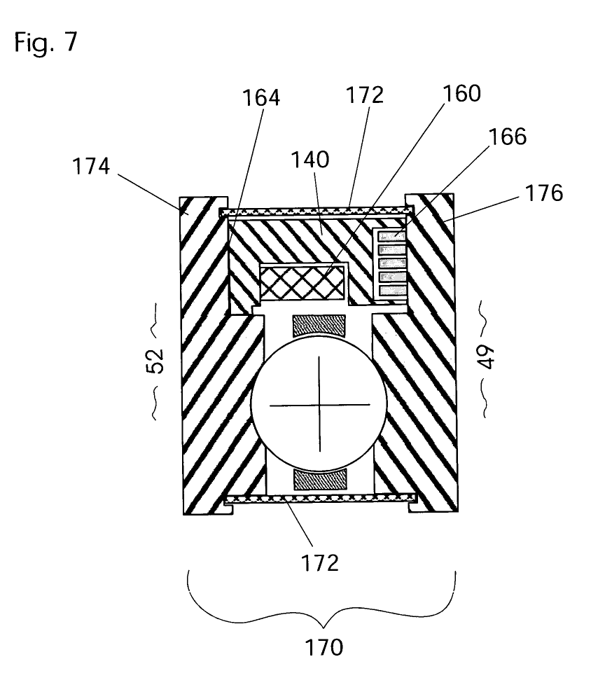

In FIG. 7, the aforesaid structures are mounted inside a bearing 170 under the seals 172. The housing 140 is trained on the outer raceway 174, and the clutch 166 is trained on the inner raceway 176. The clutch 166 allows rotation freely and unrestricted in the direction depicted by arrow 61, as above. In the event of rotation in the direction 60 which generally occurs during kickback and rollback, the clutch 166 positively engages inner raceway 176 and arm structure 49 locking the pulley 52 and the arm structure 49 together, as above. Upon reaching the designed torque level, housing structure 140 contact area 164 will slip and limit the torque to the designed level.

Throughout this specification, unless the context requires otherwise, the word “comprise,” and variations such as “comprises” or “comprising,” will be understood to imply the inclusion of a stated integer or step or group of integers or steps but not to the exclusion of any other integer or step or group of integers or steps. The ratchet and pawl mechanisms forming one-way clutches are to be understood as including equivalents such as spring clutches, sprag clutches and roller ramp clutches.

1. A timing belt autotensioner comprising first movable means contactable with a timing belt and in response to the direction of movement of the timing belt movable relative to a first location, second movable means supporting the first movable means and first location, said second movable means movable relative to a second location, and said second location spaced from the first location,
one-way engagement means adapted to remain disengaged in response to movement of the timing belt in a preferred direction and to engage in response to movement of the timing belt in the other direction, said one-way engagement causing engagement of the first movable means with the second movable means whereby the second movable means moves the first location and first movable means toward the timing belt, and
torque limiting means adapted to cause the one-way engagement means to at least momentarily release the one-way engagement means upon attainment of a predetermined torque during movement of the timing belt in the other direction.

2. A timing belt autotensioner comprising a pulley contactable with a timing belt, said pulley rotatable about a first axis at the pulley center, an eccentric arm structure supporting the pulley about the first axis and rotatable about a second axis, said second axis being spaced from the first axis,
one-way engagement means adapted to remain disengaged with rotation of the pulley in a preferred direction and to engage with rotation of the pulley in the other direction, said one-way engagement causing engagement of the pulley with the eccentric arm structure whereby the eccentric arm structure moves the first axis of rotation and pulley toward the timing belt, and
torque limiting means adapted to cause the one-way engagement means to at least momentarily release the one-way engagement means upon attainment of a predetermined torque during movement of the pulley in the other direction.

3. In a timing belt autotensioner comprising a pulley rotatable about a first axis and adapted to contact a timing belt, and an eccentric arm structure rotatable about a second axis spaced from the first axis, said eccentric arm structure supporting the pulley about the first axis and adapted to urge the first axis and pulley toward the timing belt during a preferred rotation of the pulley,
the improvement comprising a one-way clutch between the pulley and eccentric arm structure, said one-way clutch engageable in response to the other rotation of the pulley thereby rotating the eccentric arm structure to move the first axis and pulley toward the timing belt, and
torque limiting means adapted to cause the one-way clutch to at least momentarily release upon attainment of a predetermined torque during other rotation of the pulley.

4. The timing belt autotensioner of claim 3 wherein the one-way clutch is a ratchet comprising at least one pawl and a ratchet wheel.

5. The timing belt autotensioner of claim 3 wherein the one-way clutch is diametrically less than the diameter of the pulley.

6. In a timing belt autotensioner comprising a pulley rotatable about a first axis and adapted to contact a timing belt, and an eccentric arm structure rotatable about a second axis spaced from the first axis, said eccentric arm structure supporting the pulley about the first axis, and adapted to urge the first axis and pulley toward the timing belt during a preferred rotation of the pulley,
the improvement comprising a one-way clutch and gear train between the pulley and eccentric arm structure, said one-way clutch and gear train engageable in response to the other rotation of the pulley thereby causing the gear train to rotate the eccentric arm structure to move the first axis and pulley toward the timing belt, and
torque limiting means adapted to cause the one-way clutch to at least momentarily release upon attainment of a predetermined torque during other rotation of the pulley.

7. The timing belt autotensioner of claim 6 wherein the one-way clutch and gear train comprises at least one pawl and ratchet wheel, said ratchet wheel including a first gear,
a second gear meshed with the first gear and rotatable about a fixed third axis, and gear teeth on the eccentric arm structure, said gear teeth meshed with the second gear.

8. The timing belt autotensioner of claim 6 wherein the one-way clutch and gear train is diametrically less than the diameter of the pulley.

9. In a timing belt autotensioner comprising a pulley rotatable about a first axis and adapted to contact a timing belt, and an eccentric arm structure rotatable about a second axis spaced from the first axis, said eccentric arm structure supporting the pulley about the first axis, and hydraulic means adapted to urge the first axis and pulley toward the timing belt during a preferred rotation of the pulley,
the improvement comprising a one-way clutch between the pulley and eccentric arm structure, and said second axis being spaced beyond the periphery of the pulley, said one-way clutch engageable in response to the other rotation of the pulley thereby rotating the eccentric arm structure to move the first axis and pulley toward the timing belt and the eccentric arm structure away from the hydraulic means, and
torque limiting means adapted to cause the one-way clutch to at least momentarily release upon attainment of a predetermined torque during other rotation of the pulley.

10. The timing belt autotensioner of claim 9 wherein the eccentric arm structure engages a hydraulic actuator.

11. The timing belt autotensioner of claim 10 wherein the one-way clutch is a ratchet comprising at least one pawl and a ratchet wheel.

12. The timing belt autotensioner of claim 9 wherein the one-way clutch is diametrically less than the diameter of the pulley.

13. In a timing belt autotensioner comprising a pulley rotatable about a first axis and adapted to contact a timing belt, and an eccentric arm structure rotatable about a second axis spaced from the first axis, said eccentric arm structure supporting the pulley about the first axis and adapted to urge the first axis and pulley toward the timing belt during a preferred rotation of the pulley,
the improvement comprising separate means adapted to contact the timing belt at a location spaced from the pulley contact with the timing belt, said separate means movable in response to the direction of movement of the timing belt, and in response to movement of the timing belt in a non-preferred direction, actuating movement of the eccentric arm structure to move the first axis and pulley toward the timing belt, and
torque limiting means adapted to cause the separate means to at least momentarily release upon attainment of a predetermined torque during movement of the timing belt in a non-preferred direction.

14. The timing belt autotensioner of claim 13 wherein the separate means comprises a second pulley rotatably mounted on a second arm structure, said second arm structure engageable with the eccentric arm structure.

15. The timing belt autotensioner of claim 14 wherein said second pulley includes a second one-way clutch engageable in response to movement of the timing belt in the non-preferred direction.

16. The timing belt autotensioner of claim 14 wherein gear teeth on the second arm structure and eccentric arm structure mesh to provide the engagement.

17. The timing belt autotensioner of claim 14 including a limit stop to prevent over centering of the second arm structure.
